(19) United States
(12) Patent Application Publication
(10) Pub. No.: US 2001/0052125 A1
(43) Pub. Date: Dec. 13, 2001

(54) System for authoring contents of digital television and method therefor

(76) Inventor: Moon-Young Kim, Koyang-shi (KR)

Correspondence Address: eFirm, Ltd., 6208A Old Franconia Road, Alexandria, VA, 22310, US

(21) Appl. No.: 09/876,054

(22) Filed: Jun. 8, 2001

(30) Foreign Application Priority Data
Jun. 8, 2000 (KR) 10-2000-31441
May 15, 2001 (KR) 10-2001-26501

(51) Int. Cl. H04N 5/445; G06F 3/00; G06F 13/00

(52) U.S. Cl. 725/47

(57) ABSTRACT

A system for authoring the contents of a digital television and a method therefor are provided. The system includes a resource management system for managing the resource of the contents included in a broadcast program, a component management system for managing components, in which elements that can be embodied or visualized by a programmer on the screen of a digital television using the contents as a material are programmed, an application preparing system for receiving a resource and components from the resource management system and the component management system and processing and editing the contents of the broadcast program, a preview system for modifying the prepared contents, while examining the contents on a computer, and a JAVA code generation system for converting the examined contents into the JAVA language.

### BACKGROUND OF THE INVENTION

1. Field of the Invention

The present invention relates to a system for authoring the contents of a digital television and a method therefor.

2. Description of the Prior Art

A broadcasting station can transmit various information items related to a broadcast program as well as a video and a speech in a digital broadcasting unlike in an analog broadcasting. This can be performed because not an analog radio wave but a digital radio wave is transmitted to a viewer by a digital modulation method. Any viewer who has a digital television that can receive the digital radio wave can directly search and store information and can edit stored data as the viewer wishes as well as can receive various information items related to the broadcast program. Since the viewer can transmit his or her opinion to the broadcasting station in real time the moment the viewer views the broadcasting, bidirectional information transmission can be performed. Therefore, the broadcasting station must transmit various information data items that the viewer wishes to obtain as well as the video and speech data of a broadcast program to be broadcasted. In order to perform this, it is necessary to appropriately process various information items related to the broadcast program and to provide them.

Here, the various information items related to the broadcast program are referred to as contents in the present invention. The broadcasting station needs a tool for authoring the contents, which can appropriately process the contents and provide them to the viewer so that the viewer can conveniently access and acquire the contents.

A standard technology referred to as a language for manufacturing the authoring tool of the contents is divided into a hyper text markup language (HTML) technology and a JAVA technology.

The HTML is a standard language well known through the Internet, which is designed as a means of expressing documents including multimedia files in the Internet and exchanging the documents with each other. However, it is much restricted to apply the HTML to a television that receives digitalized data. This is because a computer is under different circumstances from the circumstances of a television.

Since various central processing units (CPU) and managing systems are used in a television according to manufacturing companies unlike in a computer, it is not possible to standardize the CPUs and the managing systems as hardware. The contents for a television have different characteristics from the characteristics of the contents for a computer. A remote controller unlike mainly operates a television that a computer uses a mouse or a keyboard as inputting and selecting means. Also, the contents prepared for a television must be different from the contents prepared for a computer in respect to the sizes of characteristics, the arrangement of a screen, and an operation method. It is common that the contents for a television, which are prepared by the HTML, are prepared by a quite different method from the method of use of a general HTML.

It is not possible for a computer and a television to share the same contents only by manufacturing the contents by the HTML. Furthermore, it is not possible to minutely control the contents by the HTML. For example, the same web pages may look different in a computer according to the kind of the web browser used by a user. The shapes or the operation methods of the same HTML documents vary according to the manufacturing company in the case of a television. This is because the HTML is not a language for describing the correct shape of a screen but a language restricted in extendibility.

Contrary to the above problems of the HTML, the JAVA created to be built in household electric appliances such as a television has been firmly established as the Internet language mainly in relation to a web since it appeared in 1995. The JAVA language is a kind of software execution circumstance that makes various types of computers that use different types of hardware and operation systems look identical as software rather than a programming language. Namely, a program prepared by the JAVA performs the same function as the software executed by a general operation system, however, is identically applied to any type of hardware that includes the JAVA technology and is executed. Since the JAVA is a lower structure required for showing information rather than a language designed for easily expressing documents including multimedia information like the HTML, the JAVA has extendibility and flexibility.

The JAVA has the following problems as a technology to be used for a system for authoring the contents for a television that receives digital data in the present invention due to such characteristics.

In order to edit and appropriately process the contents, a JAVA programming technology is necessary. However, as mentioned above, since the JAVA is not a technology only for creating multimedia contents, significantly complicated programming is required for constructing a relatively simple screen. Since it is difficult to process the contents in a level satisfactory to the viewer only by programmers that performs the programming process of the JAVA language, it is necessary to cooperate with designers in order to design the screen, through which the contents are provided, more beautifully. This is not desirable in respect of expenses used for manpower and efficiency for business cooperation since developing tools are mainly based on programming knowledge. Although many tools that help the JAVA programming are already developed, they are basically performed by the programmers.

Since there are limitations in the designers' easily processing the contents due to the above problems, a development circumstance, in which the programmers only have to swiftly program items that are required for processing the contents and are requested by the designers and to swiftly provide the items to the designers and, when the items requested by the designers are programmed and transmitted, the designers only have to process the contents using the items, is required. In a conventional technology, a system for authoring the contents, which is capable of establishing such a development circumstance, does not exist.

### SUMMARY OF THE INVENTION

Accordingly, it is an object of the present invention to provide a system for authoring the contents of a digital television, which is capable of establishing a convenient and strong manufacturing circumstance for processing and editing the contents.

To achieve the above object of the present invention, there is provided a system for authoring contents of a common digital television, comprising a resource management system for managing the resource of the contents included in a broadcast program, a component management system for managing components, in which elements that can be embodied or visualized by a programmer on the screen of a digital television using the contents as a material are programmed, an application preparing system for receiving a resource and components from the resource management system and the component management system and processing and editing the contents of the broadcast program, a preview system for modifying the prepared contents, while examining the contents on a computer, and a JAVA code generation system for converting the examined contents into the JAVA language.

### BRIEF DESCRIPTION OF THE DRAWINGS

The above object and other advantages of the present invention will become more apparent by describing preferred embodiments thereof in detail with reference to the attached drawings in which:

FIG. 1 is a flowchart showing processes of authoring contents according to the present invention;

FIG. 2 shows the structure of a system for authoring contents according to the present invention;

FIG. 3 shows the structure of an example of a scene manager according to the present invention;

FIG. 4 shows the structure of an example of a scene according to the present invention;

FIG. 5 shows the structure of an example of a scene corrector according to the present invention;

FIG. 6 shows the structure of an example of a component manager according to the present invention;

FIG. 7 shows the structure of an example of a component characteristic editor according to the present invention;

FIG. 8 shows the structure of an example of a script editor the describes an event handler according to the present invention;

FIG. 9 shows the concept of a layer according to the present invention;

FIG. 10 shows the structure of an example of a shot effect editor according to the present invention;

FIG. 11 is a flowchart showing the fabrication of an application according to the present invention;

FIG. 12 is a flowchart showing the design of a scene or a package according to the present invention; and

FIG. 13 is a flowchart of a preview system according to the present invention.

### DETAILED DESCRIPTION OF THE PREFERRED EMBODIMENTS

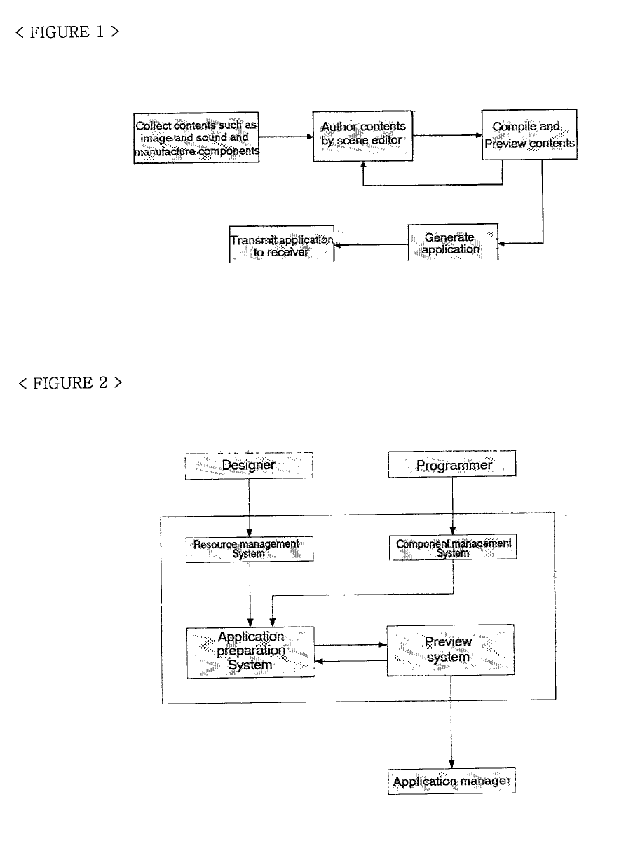

FIG. 1 is a flowchart showing processes of authoring contents. A designer collects various contents related to a broadcast program. A programmer manufactures elements that can be embodied or visualized on the screen of a digital television through programming using the collected contents as a material. At this time, the respective elements embodied on the screen of a television are defined as a component in the present invention. The final form actually displayed on the screen of the digital television of a viewer is settled by a modification work of processing the contents through a system for authoring the contents according to the present invention using a manufactured component, compiling the processed contents, and checking the contents through the display screen of a computer by a preview function. An application file that is a transmission file for sending the final form to the viewer is manufactured. The application file is the resultant generated by the system for authoring the contents according to the present invention. Therefore, a viewer who views a broadcast program can view the broadcast program more variously by simultaneously receiving various contents data items included in the application file related to the broadcast program together with the picture and speech data of a transmitted broadcast program.

FIG. 2 shows the structure of a system for authoring contents according to the present invention. A system according to the present invention includes a resource management system for managing the resource of the contents included in a broadcast program, a component management system for managing components, in which elements that can be embodied or visualized by a programmer on the screen of a digital television using the contents as a material are programmed, an application preparing system for receiving a resource and components from the resource management system and the component management system and processing and editing the contents of the broadcast program, a preview system for modifying the prepared contents, while examining the contents on a computer, and a JAVA code generation system for converting the examined contents into the JAVA language.

The system for authoring the contents according to the present invention, which has the above structure, includes design elements for processing and editing the contents, that is, a scene, a layer, a shot, and an event handler. The design elements will now be described in detail.

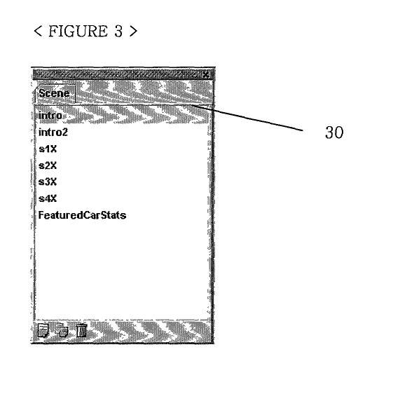

The scene includes all of the information items related to the final screen structure actually displayed on the screen of the digital television of the viewer. One or more scenes can be included in a broadcast program. The various scenes can provide the viewer a screen that variously changes by being switched with each other. FIG. 3 shows an example of a scene manager 30 for searching which file currently exists in the application file. This shows an example where the contents of a broadcast program consist of seven scenes.

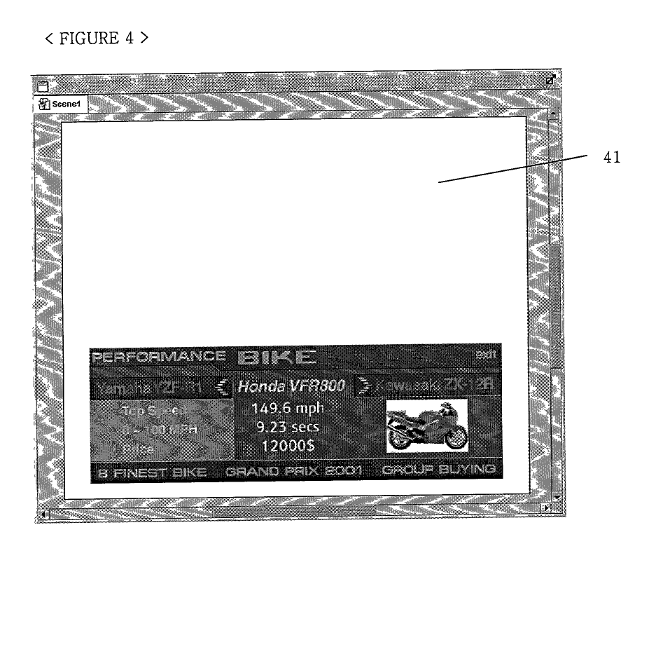

FIG. 4 shows an example 40 of the scene designed by the system according to the present invention. This is identical to the screen actually viewed on a digital television by viewers.

Referring to FIG. 4, an actual broadcast screen is televised on a screen 41 of a scene and menus 42 that contain various contents such as the ‘FINEST BIKE’, the ‘GRAND PRIX 2001’, the ‘GROUP BUYING’, and the ‘direction key’, which are capable of selecting information on the broadcasted program, are arranged in the lower end of the scene. Therefore, a viewer only has to select the menu desired by the viewer through a remote controller in order to obtain the information on the broadcasted contents. The scene is initially an aggregate of lattices, which is referred to as a grid, like graph paper where nothing is drawn. An example of a scene shown in FIG. 4 is formed by a user of the system for authoring the contents according to the present invention arranging various components on the grid and designing the scene.

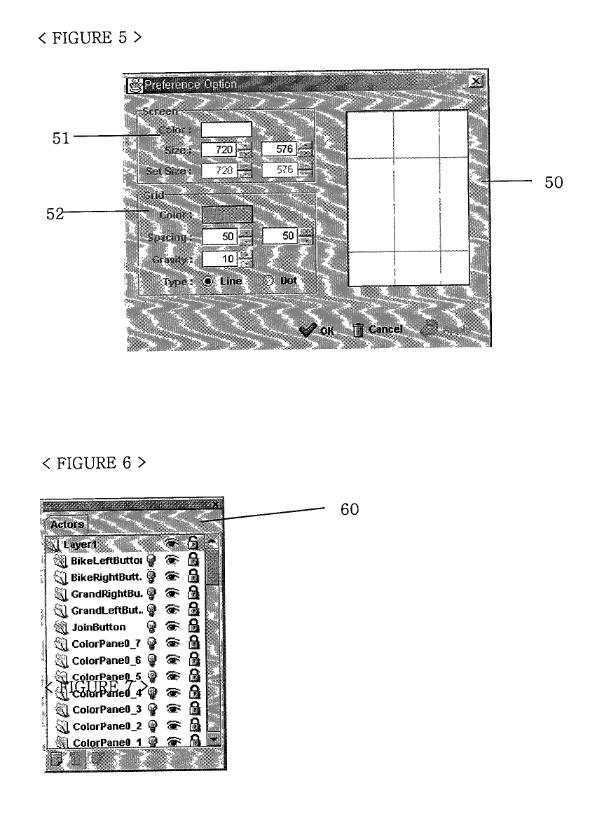

FIG. 5 shows an example of a scene corrector 50 for correcting the screen of a scene. The scene corrector 50 has a screen controller 51 for controlling the color and the size of a screen on the left top and a grid controller 52 for controlling the color and the size of a grid on the left bottom in order to minutely control a screen in units of lattices. The user can minutely control the color and the size of a scene using the scene corrector.

The component included in a scene can be arbitrarily control on the scene using a component manager and a component characteristic editor, which are provided by the system according to the present invention.

FIG. 6 shows an example of a component manager 60 for systematically managing components. Components are displayed. In particular, the arrangement structure of a scene, a layer, and components included in the layer is a tree-structure. A user easily changes the components by simply operating a mouse in the tree-structure using the component manager 60. The user can systematically manage the components.

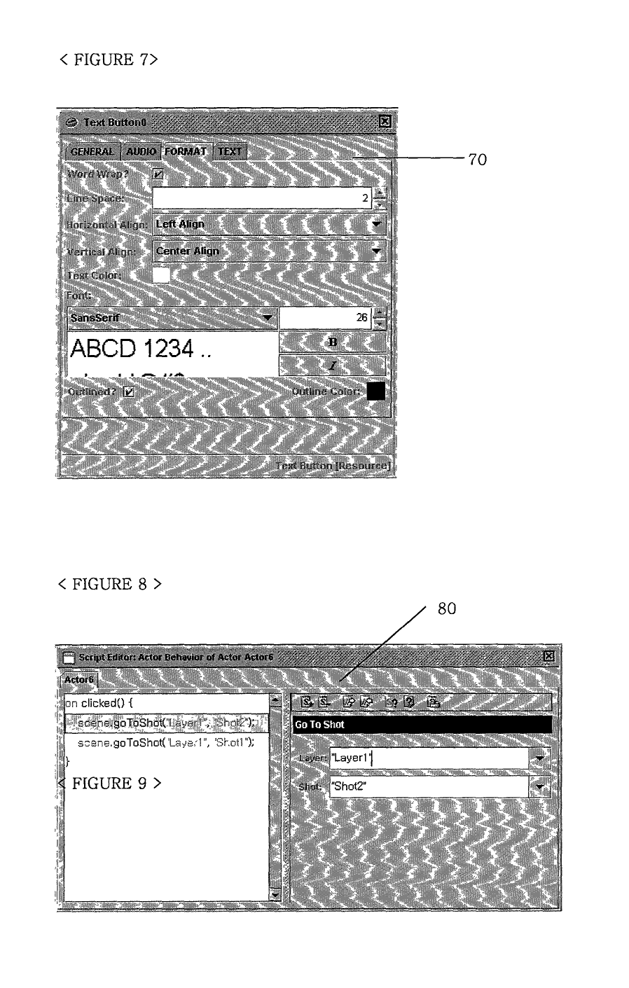

FIG. 7 shows an example of a component characteristic editor for controlling the respective characteristics of the component. Referring to FIG. 7, the component characteristic editor includes a characteristic corrector for correcting a general characteristic and the characteristics of an audio, a text, and a text format. A user who uses the system for authoring the contents according to the present invention can control the name, the size, the visual characteristic, the visibility factor, and the font of the characteristics of a component through the editing window as he or she wishes.

Also, the component characteristic editor according to the present invention provides the following improved functions compared with a general characteristic editor. The general characteristic editor uses an editor basically provided according to the characteristic of a component or directly manufactures an editor. The general characteristic editor is in the form of a simple table where a name that controls the characteristic and the control value make a pair. Therefore, it is inconvenient for the user to look for desired characteristics in the characteristic editor. It is difficult to perform an intuitive edition since each characteristic value editor is restricted by the size of a table and an expression is restricted, accordingly. The general characteristic editor does not have a function of gathering a plurality of characteristic elements by category and showing the characteristic elements. Therefore, in order to relax such restriction items, when a component manufacturer creates the characteristic editor, the component manufacturer must directly perform programming in almost cases. Contrary to this, since it is possible to design an editor using the extensible markup language (XML) that can be easily learned according to the characteristic editor of the present invention, it is possible to add characteristic elements to a component in the form of a file and to freely arrange characteristic controlling elements on a screen using the XML tag. It is possible to divide the characteristic elements by the category of each component. It is possible for the component manufacturer to easily add and arrange the characteristic editor without performing complicated programming.

After arranging the respective components and defining the characteristics of the components by the above explanation, it is necessary to describe the operation to be performed when accidents unique to the respective components (circumstances that occur when the user inputs something to the components or when the user presses a certain button, hereinafter, an event) occur. A set where the order of such operations is referred to s an event handler. A method of describing the event handler is provided by the system according to the present invention.

The method of describing the event handler according to the present invention includes recording and a script editor. In the recording, the circumstance generated when an event occurs in a scene editor is expressed in a descriptive way. It is possible to previously show the circumstance when the event occurs and for users who are not familiar with the event handler to easily prepare the event handler by the recording. Since the recording result is immediately switched and is displayed on a screen, it is possible to modify the result as desired by a designer according to circumstances. Meanwhile, the script editor is suitable for describing a more complicated event handler. Since a tool that describes the event handler using the script language that supports the JAVA language is provided by the system according to the present invention, it is possible for the contents manufacturer to easily describe a complicated action according to the event without using the JAVA language that is difficult to be used.

FIG. 8 shows an example of a script editor 80 for describing the event handler according to the present invention. Referring to FIG. 8, the kind of an accident that calls the event handler is displayed on the left top 81 of the editor (FIG. 8 shows a state in which a button is clicked). It is possible to select various script functions.

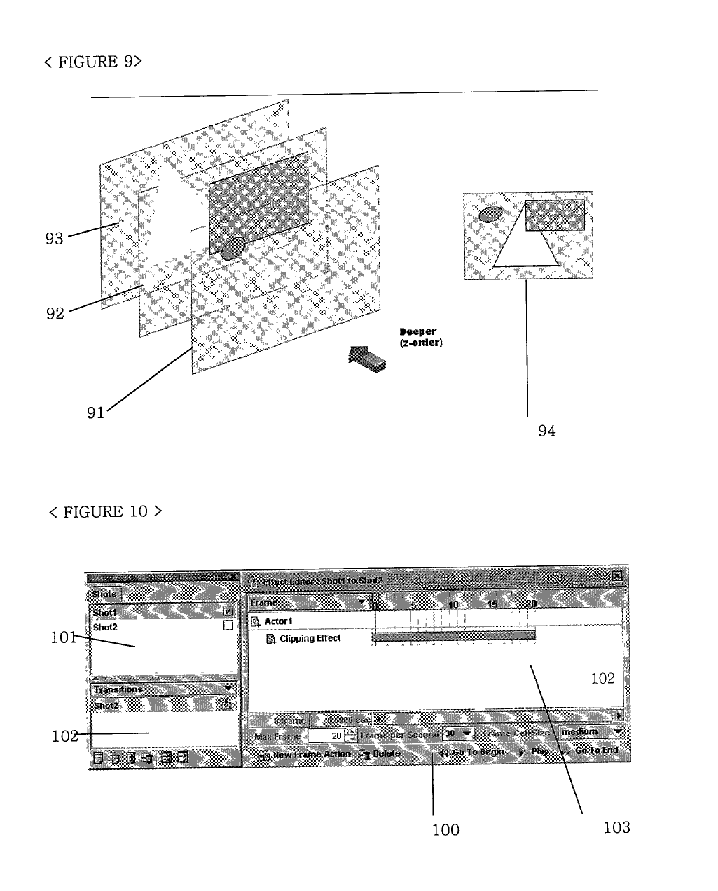

FIG. 9 shows an example of the concept of a layer according to the present invention. The layer operates as a container that contains visual components inserted into the scene. One or more layers are inserted into the scene. The size of the screen of each layer is equal to the size of the screen of the scene. Referring to FIG. 9, the respective layers 91, 92, and 93 are overlapped with each other like a plurality of cards. Since the depth values of the respective layers are different from each other, the depths of the layers in the scene are different from each other. The component that belongs to the layer having a large depth value is always located above the component that belongs to the layer having a small depth value. Therefore, a scene 94 obtained by synthesizing the layers 91, 92, and 93 is as shown in FIG. 9. Since the user can arrange a plurality of layers having different depths in the scene, it is possible to design scenes in more various forms.

A shot that is a design element according to the present invention is a kind of still image with respect to the scene and can produce various visual changes of the scene. Namely, when a shot is changed into another shot, since a movement between two shots can be expressed and a medium effect can be designated, it is possible to easily set a screen effect when the state of a screen is switched using the shot. FIG. 10 shows an example of a shot effect editor 100 for setting the screen effect when the switching from the shot 1 to the shot 2 is made. The left window includes a shot display 101 and a shot movement designator 102 for displaying the movement between a shot and another shot. The right window includes an effect editor 103 for designating the effects of the respective components during the movement. In an example shown in FIG. 10, the shot 1 and the shot 2 are designated by the shot display 101 and the shot 2 is designated by the shot movement designator 102. The shot moves, while being clipped, as an effect is designated by the effect editor 103 during the movement from the shot 1 to the shot 2.

The system for authoring the contents according to the present invention provides a tool for previously creating the form of a scene that is frequently designed when a user manufactures the contents and managing the form so as to be continuously used. The design of the form of the scene that is frequently used is referred to as a package. The user can previously design the scene in the form of the package and immediately use the scene for a part that requires the scene during the authoring of the contents. The system according to the present invention provides the package manager for managing the package.

The package is the object of a scene, which is inserted into the scene. The package is conceptually similar to the scene and has almost characteristics of the scene such as the layer, the shot, and the event handler. However, a package cannot include another package. In case where the package occupies a layer in the scene when the package is inserted into the scene, components in the package have the same value as the value of the layer of a corresponding scene.

The components in the package are not affected by the shot of the scene that includes the package. The package includes a global package and a local package. The global package is loaded in a memory when the data contents start and exists until a program is terminated. The local package is generated when the scene into which the local package is inserted is generated and is removed when the scene is removed. When the package is included in the scene, it is possible to redefine the event handler of the package in the scene and to use the event handler. The event handler of the package can approach the component in the scene. The change in the characteristic of the package such as the change in the shot of the package must be able to be performed in the same method as the change in the characteristic of a component of a corresponding scene.

A package is selected or a new package is created and edited by a package manager. The edition of a package is identical to the edition of a scene excluding that a package cannot be included in another package. It is possible to edit the package included in the corresponding scene when the scene is edited. At this time, a mode is changed into a package edition mode in a state where the parts of the scene, which are not included in the package, remain as they are. At this time, the entire edition means change so as to reflect the state of the package. The components of the scene, which are not included in the corresponding package, are shown on a screen, however, cannot be edited in the package edition mode.

The designers and the programmers manufacture the application file to be finally transmitted to the viewer by authoring the contents using the collected resources and components. Therefore, the method for authoring the contents according to the present invention is a method for preparing the application file.

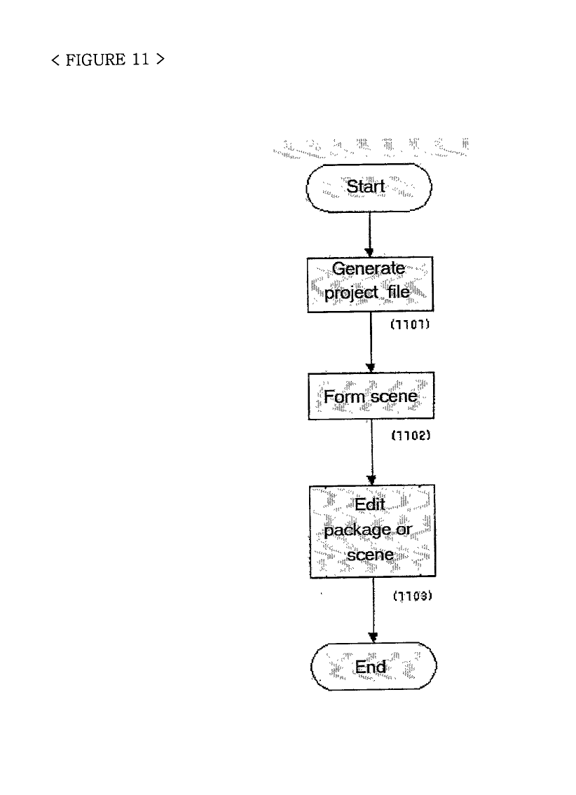

FIG. 11 is a flowchart showing how to prepare the application file. According to the present invention, a project file must be generated (step 1101) in order to manufacture a new application file. The project file is the aggregate of the contents suitable for the subject of broadcasting to be designed by the designer. The scene, the layer, the package, the shot, and the event handler are included in the project file. After generating the project file, the scene to be displayed on the display screen of the viewer is formed using the scene manager 30 (step 1102). The formed scene or package is edited after forming the scene (step 1103).

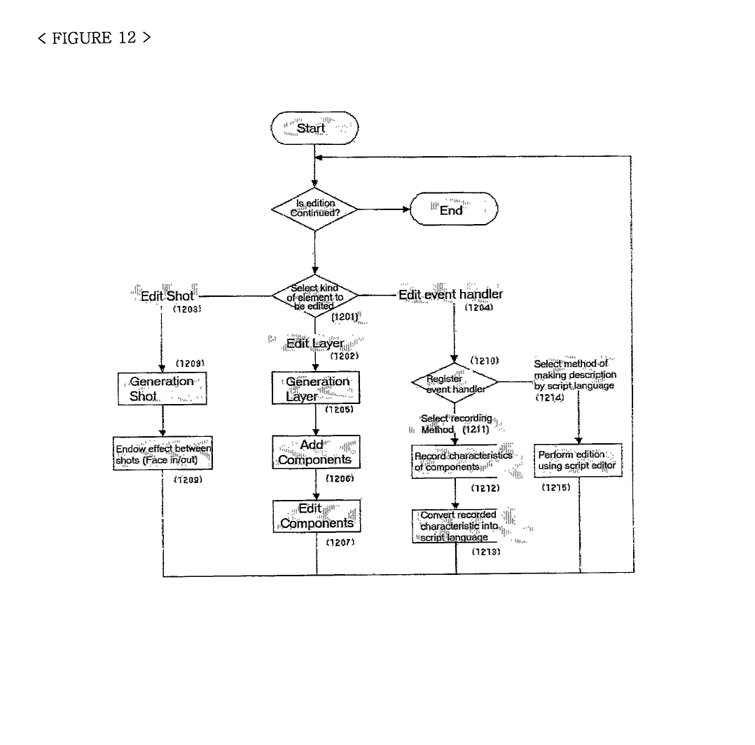

Editing a scene or a package means connecting the shot, the layer, the component, and the event handler that are included in the scene to each other and organically forming them. The step of editing the scene or the package will be described in detail with reference to FIG. 12.

FIG. 12 shows processes of asking which is to be edited among the shot, the layer, and the event handler, terminating the generation of the respective elements, and integrating the respective elements. A component is added after a layer is generated and the respective components can be edited using the component characteristic editor. A new shot can be created by copying a specific shot or generating a new shot. The movement between shots can be designed in more various forms using the shot effect manager. The event handler records what happened in the component using the recording method and the method of using the script language.

The step of forming the scene and editing the formed scene or package comprises the steps of (1201) selecting the kind of an element to be edited, (1202) proceeding to a step of editing a layer when the selected element to be edited is the layer, (1203) proceeding to a step of editing a shot when the selected element to be edited is the shot, and (1204) proceeding to a step of editing an event handler when the selected element to be edited is the event handler. The step (1202) comprises the steps of (1205) generating a layer, (1206) adding components to the generated layer, and (1207) editing the components using a component characteristic editor. The step (1203) comprises the steps of (1208) generating a shot and (1209) endowing an effect between shots using an effect manager. The step (1204) comprises the steps of (1210) registering the event handler. Here, either the recording method or the method of using the script language is selected as the method of describing the event. At this time, the recording method is selected (1211), the step (1212) of recording the operations performed by the user on the scene as they are and recording them as the characteristics of the components and the step (1213) of converting the recorded characteristics into the script language are performed. When the method of describing the event using the script language without performing the recording method is selected (1214) in the recording step (1210), the event is described through the step (1215) of performing edition using the script editor.

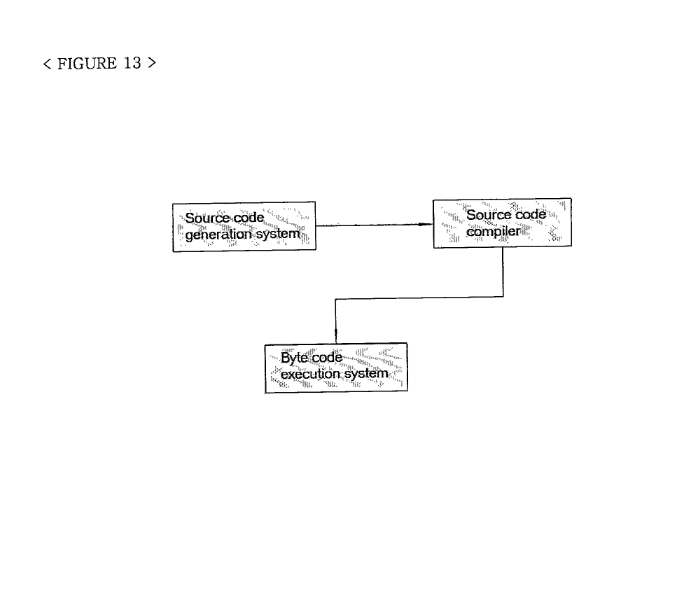

As mentioned above, the design of the contents by a system for preparing an application is terminated, it is necessary to previously check how the details of the contents will be actually displayed on a screen before transmitting the contents to viewers. Therefore, it is possible to previously check how the details of the contents will be actually displayed on a screen by a preview system shown in FIG. 13 in the system according to the present invention. It is possible to modify and examine the contents by the preview system through processes of generating the created contents by a JAVA source code and compiling and executing the contents on a computer. The contents finally established through the preview system are transmitted to the digital television of the viewer together with the details of broadcasting.

It is possible to perform the following works using the characteristics of the system according to the present invention. It is possible to control hardware such as an on screen display (OSD) and the channel, the screen, and the volume of a television, that is, to support new media such as a moving picture of a new form and to perform special services such as a multiple point of time sports relay using a multi-channel. A broadcasting station can create an electronic program guide (EPG) suitable for the channel thereof and can prepare interactive contents that react to the information transmitted in a real time, for example, the contents capable of performing a public opinion census and home shopping on the screen of a television. Such information can be transmitted to a plurality of objects at high speed compared with a general Internet connection due to the characteristics of the broadcasting. Also, it is possible to realize network of various forms through a back channel. It is possible to use protocols of any forms such as a protocol for a real time game as well as a mail protocol such as the post office protocol (POP) and the Internet message access protocol (IMAP) and a media streaming protocol such as the real time transport protocol (RTP) as the need arises without being restricted to a protocol of a specific form such as the hyper text transfer protocol (HTTP) of the hyper text markup language (HTML).

According to the present invention, since it is possible to easily form and switch a screen by an intuitive editor and to add special effects, designers can easily manufacture the contents without knowledge of the JAVA programming and can prepare the contents using an easy script language as the need arises.

When the programmer prepares parts required for new services by components or additionally purchases the components, the designer can manufacture the interactive contents without the help of the programmer. Accordingly, The works of the designer are effectively separated form the works of the programmer.

Since the contents are stored in the form of the XML, it is possible to automatically transform the contents using the conventional Internet technology and to insert necessary data into the contents in association with a database. Also, association with the conventional Internet technology can be easily performed.

What is claimed is:

1. A system for authoring contents of a digital television, comprising:
a resource management system for managing the resource of the contents included in a broadcast program;
a component management system for managing components, in which elements that can be embodied or visualized by a programmer on the screen of a digital television using the contents as a material are programmed;
an application preparing system for receiving a resource and components from the resource management system and the component management system and processing and editing the contents of the broadcast program;
a preview system for modifying the prepared contents, while examining the contents on a computer; and
a JAVA code generation system for converting the examined contents into the JAVA language.

2. A method for authoring the contents of a digital television, comprising the steps of:
generating a project file including a scene, a layer, a package, a shot, and an event handler as an aggregate of the contents suitable for the subject of broadcasting;
generating the project file and forming a scene included in the project file; and
forming the scene and editing the formed scene or package.

3. The method of claim 2, wherein the scene is a picture, which is displayed on the screen of the digital television of a viewer and in which a layer, a shot, a component, and an event handler are arranged.

4. The method of claim 2, wherein the package is obtained by previously creating the form of the scene that is frequently designed.

5. The method of claim 2, wherein one or more layers are included in the scene, are overlapped with each other, and have different depth values.

6. The method of claim 2, wherein a shot is a kind of a still image with respect to the scene, and
wherein, when a shot is changed into another shot, a movement or a medium effect between two shots can be designated.

7. The method of claim 2, wherein the step of forming the scene and editing the formed scene or package comprises the steps of:
(1201) selecting the kind of an element to be edited;
(1202) proceeding to a step of editing a layer when the selected element to be edited is the layer;
(1203) proceeding to a step of editing a shot when the selected element to be edited is the shot; and
(1204) proceeding to a step of editing an event handler when the selected element to be edited is the event handler.

8. The method of claim 7, wherein the step (1202) comprises the steps of:
(1205) generating a layer;
(1206) adding components to the generated layer; and
(1207) editing the components using a component characteristic editor.

9. The method of claim 8, wherein the component characteristic editor can freely arrange characteristic control elements on a screen using an extensible markup language (XML) tag.

10. The method of claim 7, wherein the step (1203) comprises the steps of:
(1208) generating a shot; and
(1209) endowing an effect between shots using an effect manager.

11. The method of claim 7, wherein the step (1204) comprises the steps of:
(1210) registering the event handler;
(1211) selecting a recording method; and
(1214) selecting a method of making a description by a script language when the recording method is not selected.

12. The method of claim 11, wherein the recording method comprises the steps of:
(1212) recording a component characteristic by the recording method; and
(1213) converting the recorded characteristic into the script language.

13. The method of claim 11, wherein the method of making a description by the script language comprises the step of (1215) performing edition using a script editor.
